(19) United States
(12) Patent Application Publication
(10) Pub. No.: US 2015/0063205 A1
(43) Pub. Date: Mar. 5, 2015

(54) MOBILE STATION AND METHOD FOR ANONYMOUS MEDIA ACCESS CONTROL ADDRESSING

(71) Applicant: Brent Elliott, Hillsboro, OR (US)

(72) Inventor: Brent Elliott, Hillsboro, OR (US)

(21) Appl. No.: 14/125,895

(22) PCT Filed: Aug. 29, 2013
(86) PCT No.: PCT/US2013/057300

§ 371 Date: Dec. 12, 2013

(51) Int. Cl. H04L 29/12; H04W 8/26

(52) U.S. Cl. CPC H04L 61/6022; H04W 8/26
USPC 370/328

(57) ABSTRACT

Embodiments including methods and apparatuses for secure wireless communication through use of one or more temporary MAC addresses to identify a mobile station in a WiFi environment are generally described herein. For example, a method is presented for secure wireless communication, which includes generating a temporary media access control (MAC) address in one or more mobile stations, establishing a lifetime period of the temporary MAC address, optionally transmitting the temporary MAC address for service querying or association with an access point, determining that the lifetime period has expired, and replacing the temporary MAC address with a newly generated temporary MAC address upon determining that the lifetime period has expired.

### TECHNICAL FIELD

Embodiments described herein pertain generally to wireless communications. Some embodiments relate to temporary media access control (MAC) addressing in wireless environments, such as WiFi networks and networks configured to communicate via the Institute of Electrical and Electronics Engineers (IEEE) 802.11 family of specifications.

### BACKGROUND

Many current mobile stations (STA), which include mobile devices, intermittently broadcast a unique MAC address corresponding to the mobile device. These intermittent broadcasts leave these STAs susceptible to third-party tracking, hacking, and viruses. Though temporary MAC address protocols have been suggested as a solution to this problem, none are back-compliant with existing access point software. Thus, there is a need for a temporary MAC address protocol that is compliant with existing access point protocols.

### BRIEF DESCRIPTION OF THE DRAWINGS

FIG. 1 is a schematic diagram illustrating a system for wireless communication, according to an example embodiment;

FIG. 2 is a block diagram illustrating a temporary MAC address module, according to an example embodiment;

FIG. 3 is a flowchart illustrating a method for managing temporary MAC addressing on mobile devices, according to an example embodiment;

FIG. 4 is a block diagram of a system for temporary MAC address management in an STA;

FIG. 5 is a block diagram illustrating a machine in the example form of a computer system, within which a set or sequence of instructions for causing the machine to perform any one of the methodologies discussed herein may be executed, according to an example embodiment; and

FIG. 6 illustrates usage of temporary MAC addresses in accordance with some embodiments.

### DETAILED DESCRIPTION

The present disclosure provides methods and apparatuses for enhancing MAC addressing in wireless networks. Specifically, the present disclosure presents methods and apparatuses that maximize the privacy of an STA while simultaneously maximizing the interoperability of the STA with existing networks and access points.

In an aspect of the present disclosure, an STA may choose or generate one or more random temporary MAC addresses (e.g. Locally Administered Addresses), which may allow for some or all of the individual bits comprising a MAC address to be randomly generated as to be compliant with existing network communication standards (e.g. WiFi and/or standards promulgated by the Institute of Electrical and Electronics Engineers (IEEE)). In an aspect, such temporary addresses described herein may have an associated lifetime of as short as a few milliseconds or less or may be reused in one or more specific contexts to have an effective lifetime corresponding to the lifetime of a network profile of the STA. Thus, the methods and apparatuses provided herein may be configured to select an appropriate lifetime for a temporary MAC address associated with the STA such that maximum privacy and interoperability with existing and future communication standards and access point technologies may be achieved.

For instance, in one aspect of the present disclosure, an STA may perform passive scanning, whereby the STA listens for beacons broadcast by one or more access points without transmitting any identifying frames. In another aspect, the STA may utilize a temporary MAC address scheme wherein the MAC address may have a relatively short lifetime, such as, but not limited to, on the order of 10 ms. In this aspect, each scan event may utilize a newly-generated and unique temporary MAC address in a transmitted probe request and may listen for one or more response messages corresponding to the probe request, for example, for the duration of the associated scan event on a given channel. Furthermore, the temporary MAC address may be changed with each channel scan or may persist for a period of time before the STA generates and transmits a new temporary MAC address for scanning purposes. In such examples, because there is no association between the temporary MAC address used in the scan event to potential subsequent access point-STA communications, there would be no adverse impact to using unique temporary MAC addresses for each scan event—which, in some non-limiting examples, may last for about 10-100 ms.

In an additional aspect, the methods and apparatuses of the present disclosure may be integrated in a probe request and response capacity. For example, the present methods and apparatuses may be utilized for Access Network Query Protocol (ANQP) transmissions in networks using the IEEE 802.11 family of standards (such as, but not limited to IEEE 802.11u) and/or Hotspot 2.0 communication technologies. STAs utilizing ANQP may be configured to transmit query messages to obtain information about an access point, which may include the access point domain name, roaming partners accessible via the hotspot, credential type, an Extendable Authentication Protocol (EAP) method supported for authentication, Internet Protocol (IP) address type availability, and other metadata that may be used for network selection and/or future association purposes. Because an STA MAC address may be transmitted during an ANQP query, communication according to the present disclosure may include generating and transmitting a temporary MAC address during such an ANQP query.

Furthermore, methods and apparatuses of the present disclosure may be utilized by an STA for network and/or access point association. The legacy process for association, authentication, and other management frames corresponding to STA association with a network and/or access point requires a persistent MAC address throughout the lifetime of the association. In an aspect, unlike this legacy process, the methods and apparatuses provided in the present disclosure may include selecting a temporary MAC address after scanning is complete and the STA initiates an attempt to associate and/or authenticate with a network and/or access point. In a further aspect, the STA may use the temporary MAC address until the association is terminated or until a configured time period elapses. This time period may be specified by the STA, the user of the STA, a service provider, a network, an access point, and/or the like. Furthermore, when such a timeout occurs, the STA (or access point) may reinitiate the authentication and/or association process.

Additionally, in an aspect, the STAs and access points of the present disclosure may be present in networks that use MAC address filtering, which may exclusively allow specific pre-programmed MAC addresses to connect to the network. According to the present disclosure, where a network profile associated with such a network includes an option to specify a persistent identity or MAC address, the STA may generate a temporary MAC address that will be used whenever associating with an access point and/or network (e.g. a WiFi network). Furthermore, because such network authentication schemes may compromise STA identity security by being susceptible to hacking and/or tracking, in an aspect, the access point, network, or an application run on the STA may warn the end-user of the security risk associated with utilizing persistent identity MAC addressing.

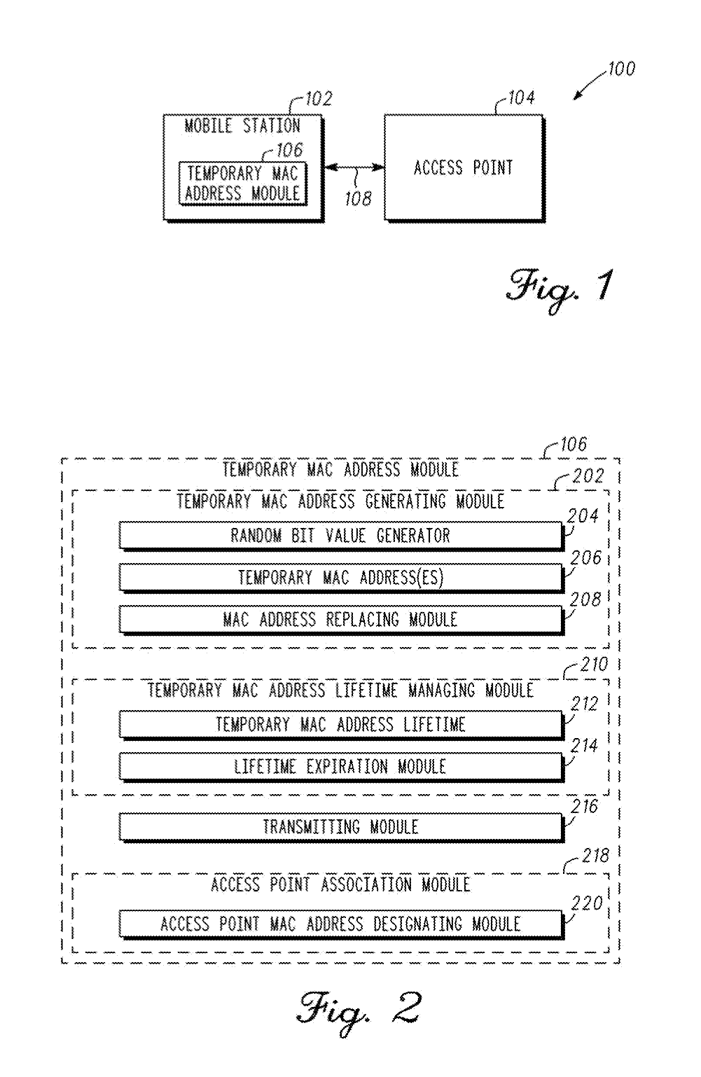

Turning to the figures, FIG. 1 is a schematic diagram illustrating a system 100 for improved STA security through use of temporary MAC addressing, according to an example embodiment. FIG. 1 includes an example STA 102, which may communicate wirelessly with an access point 104 over a wireless communication link 108.

In an aspect, the STA 102 may be a mobile device, such as, but not limited to, a smart phone, cellular telephone, mobile phone, laptop computer, tablet computer, or other portable networked device. In addition, STA 102 may also be referred to by those skilled in the art as a mobile station (STA), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In general, the STA 102 may be small and light enough to be considered portable. Furthermore, STA 102 may include a temporary MAC address module 106, which may be configured to manage MAC address generation, beacon transmission, and association with one or more access points 104 (or associated networks) for STA 102.

In a further aspect, access point 104 of FIG. 1 may include one or more of any type of network module, such as an access device or module, a macro cell, including a base station (BS), node B, eNodeB (eNB), a relay, a peer-to-peer device, an authentication, authorization and accounting (AAA) server, a mobile switching center (MSC), a radio network controller (RNC), or a low-power access point, such as a picocell, femtocell, microcell, etc. Furthermore, access point 104 may comprise an access point configured to communicate via the IEEE 802.11 family of networks or any other WiFi access point, such as, but not limited to, a WiFi hotspot. Additionally, access point 104 may communicate with one or more other network entities of wireless and/or core networks, such as, but not limited to, wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. Such network(s) may include a single local area network (LAN) or wide-area network (WAN), or combinations of LANs or WANs, such as the Internet.

Additionally, such network(s), which may include access point 104, may comprise a W-CDMA system, and may communicate with one or more STAs 102 according to this standard. As those skilled in the art will readily appreciate, various aspects described throughout this disclosure may be extended to other telecommunication systems, network architectures and communication standards. By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 or later WiFi communication standards, IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system. The various devices coupled to the network(s) (e.g. STA 102 and/or access point 104) may be coupled to the network(s) via one or more wired or wireless connections.

FIG. 2 is a block diagram illustrating an example temporary MAC address module 106 of FIG. 1, which may be configured to manage temporary MAC addressing associated with an STA (e.g. STA 102 of FIG. 1). In an aspect, temporary MAC address module 106 may include a temporary MAC address generating module 202, which may be configured to generate one or more temporary MAC addresses associated with an STA. To this end, temporary MAC address generating module 202 may include a random bit value generator 204, which may be configured to generate one or more random bits that comprise one or more temporary MAC addresses 206. For example, in some examples, random bit value generator 204 may randomly generate 46 of the 48 bits of a MAC address, which may comprise a Locally Administered Address as defined by the IEEE 802.11 family of standards, as to be compliant with IEEE and/or WiFi standards or requirements of any other wireless standard. Furthermore, temporary MAC address generating module 202 may include a MAC address replacing module 208, which may be configured to replace a prior temporary MAC address with a new temporary MAC address upon the expiration of a MAC address lifetime associated with a prior temporary MAC address. Furthermore, in another example, temporary MAC address generating module 202 may generate temporary MAC addresses 206 using the Globally Unique Addresses format defined in IEEE standards, and may use one or more Organizationally Unique Identifiers (OUIs).

In an additional aspect, temporary MAC address module 106 may include a temporary MAC address lifetime managing module 210, which may be configured to manage a temporary MAC address lifetime 212 associated with one or more temporary MAC addresses 206. In an aspect, temporary MAC address lifetime 212 may be a discrete time period, such as a number of seconds, milliseconds, or other time measurement.

Alternatively or additionally, temporary MAC address lifetime 212 may comprise the lifetime of an event, such as, but not limited to, a scanning event or an association with an access point. In an additional aspect, such a scanning event may be a probe request, request for service, or other beacon. For example, the probe request may be utilized for Access Network Query Protocol (ANQP) transmissions in networks using 802.11u and/or Hotspot 2.0 communication technologies. In such examples, temporary MAC address lifetime module may be configured to set the temporary MAC address lifetime 212 as the lifetime of the scanning event (e.g. the generation, transmission, and response wait and receiving duration).

Additionally, temporary MAC address lifetime managing module 210 may include a lifetime expiration module 214, which may be configured to determine that a temporary MAC address lifetime 212 has expired. For example, lifetime expiration module 214 may include a timer for counting down a discrete temporal period and determining that this time period that corresponds to the temporary MAC address lifetime 212 has expired. Furthermore, in examples where the temporary MAC address lifetime 212 is an event-based lifetime, such as a scan event, lifetime expiration module 214 may be configured to determine that the event has concluded and thus the temporary MAC address lifetime 212 has expired (e.g. a response timeout period has expired or a response to a scanning query is received).

In a further aspect, temporary MAC address module 106 may include a transmitting module 216, which may be configured to transmit one or more temporary MAC addresses 206 to one or more network entities, such as one or more access points. For example, the transmitting module 216 may be configured to transmit one or more temporary MAC addresses 206 during a scanning event, such as, but not limited to, during a probe request. In an aspect, transmitting module 216 may include, but is not limited to, a transmitter, transceiver, and/or computer hardware that may be configured to implement instructions for transmitting a wireless signal.

Additionally, temporary MAC address module 106 may include an access point association module 218, which may be configured to manage STA association with one or more access points corresponding to one or more temporary MAC addresses. In an aspect, access point association module may be further configured to associate a temporary MAC address of an STA with an access point after a scanning event by the STA using a different temporary MAC address. In an aspect, the associated temporary MAC address may be used until the association ends or until a timeout occurs. In some non-limiting examples, this timeout may be configured by the STA, a service provider, a network entity, a manufacturer, service provider, and/or an end user. Furthermore, in an aspect, WiFi frames controlled by the association point association module 218 (and/or transmitting module 216) may include Association Request/Response, Reassociation Request/Response, Disassociation, Authentication, Deauthentication, Power Save Polling Packet (PS-Poll), Request to Send (RTS), Clear to Send (CTS), acknowledgement (ACK), and data frames in the contest of a particular network or group of access points with a particular Extended Service Set Identification (ESSID). Furthermore, access point association module 218 may include an access point MAC address designating module 220, which may be configured to designate a particular temporary MAC address as the MAC address for use with a particular access point, network, ESSID, etc. in the future. For example, access point MAC address designating module 220 may be configured to cache one or more temporary MAC addresses for a length of time (e.g. determined by the manufacturer, end user, service provider, etc.) for subsequent associations with the same network or ESSID.

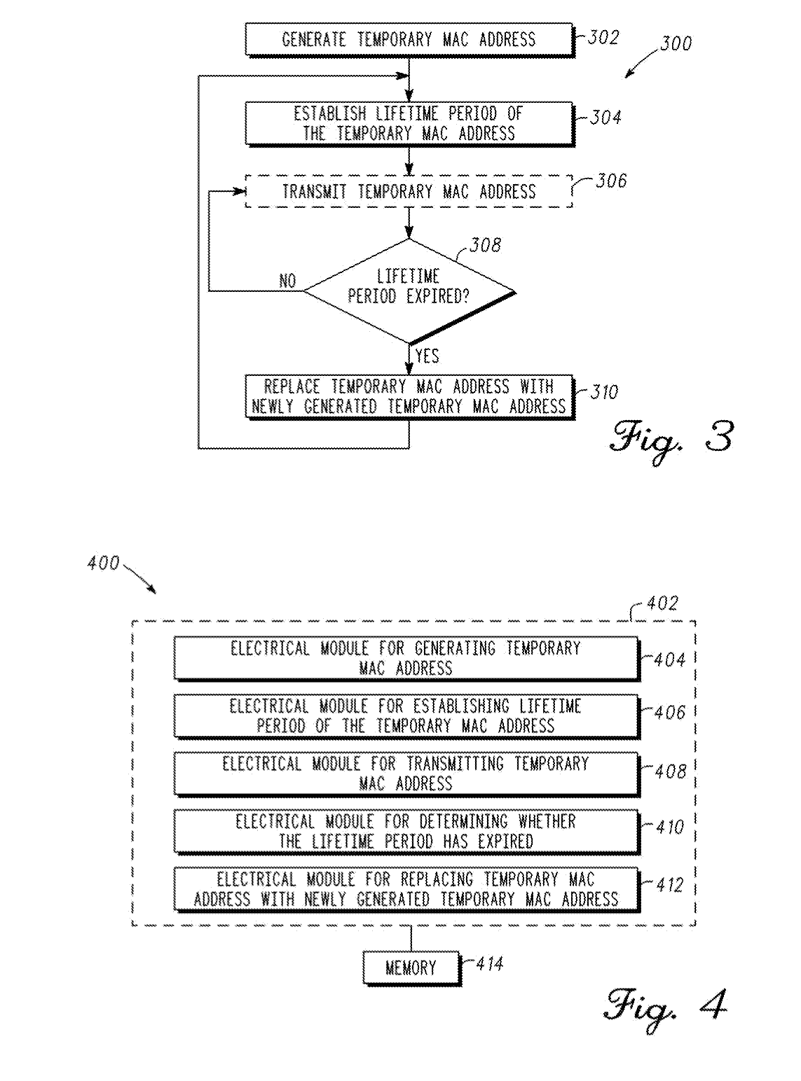

FIG. 3 is a flowchart illustrating a method 300 for improved temporary MAC address management in STAs. In an aspect, method 300 may include generating a temporary MAC address at block 302. In an aspect, generating the temporary MAC address may be for purposes of generating a newly generated MAC address to replace a current temporary MAC address. Furthermore, the temporary MAC address may be generated by generating random bits that will comprise the temporary MAC address. In an aspect, the temporary MAC address generated at block 302 may be compatible with existing wireless technology standards, such as, but not limited to, WiFi and/or IEEE standards.

Additionally, at block 304, method 300 may include establishing a lifetime period of the temporary MAC address. In an aspect, the lifetime period generated at block 304 may be a discrete temporal time period (e.g. 10 ms, 100 ms, etc.) or may be established as lasting for the duration of an event, such as a scanning event. In an optional aspect, at block 306, method 300 may include transmitting the temporary MAC address, for example, to one or more access points for scanning purposes (e.g. during a probe request transmission), for authentication with a network or access point, for associating with a network or access point, or the like.

In another aspect, at block 308, method 300 may include determining whether a temporary MAC address lifetime period has expired. In an aspect, this may include determining that a discrete temporal time period has expired. In an alternative or additional aspect, this may include determining that an event, such as a scanning event, has expired, which may include a scanning or response timeout occurrence or the receipt of a response from one or more access points (or other network devices).

Furthermore, at block 310, where it is determined that the temporary MAC address lifetime period has expired at block 308, method 300 may include replacing a temporary MAC address (e.g. a “current” temporary MAC address that was previously generated and/or transmitted) with a newly generated temporary MAC address. In an aspect, as at block 302, the newly generated temporary MAC address may be generated to comply with existing wireless communication standards, such as, but not limited to, WiFi and/or other IEEE communication standards. Furthermore, as at block 302, at block 310, the newly generated temporary MAC address may be generated by generating one or more random bits that comprise the newly generated temporary MAC address. In addition, once the newly generated temporary MAC address has replaced the original temporary MAC address, method 300 may return to block 304, where a temporary MAC address lifetime period may be established for the newly generated temporary MAC address.

In addition, returning to block 308, in an aspect, where it is determined that the lifetime period has not expired, method 300 may optionally return to block 306 to again transmit the temporary MAC address. Alternatively, the temporary MAC address may not be transmitted, and rather, the method 300 may return to block 308 until it is determined that the lifetime period has expired.

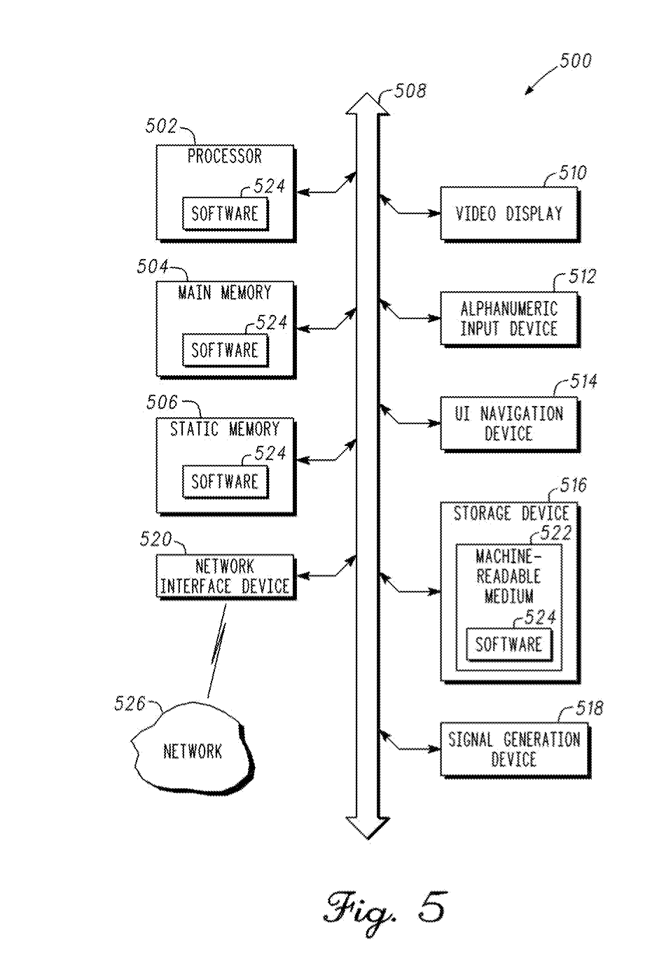

Referring to FIG. 4, an example system 400 is displayed for temporary MAC address management in an STA. For example, system 400 can reside at least partially within an STA (e.g. STA 102 of FIG. 1). It is to be appreciated that system 400 is represented as including functional blocks, which can be functional blocks that represent functions implemented by a processor, software, or combination thereof (e.g., firmware). System 400 includes a logical grouping 402 of electrical modules that can act in conjunction. For instance, logical grouping 402 can include an electrical module 404 for generating a temporary MAC address. In an aspect, electrical module 404 may comprise temporary MAC address generating module 202 (FIG. 2). Additionally, logical grouping 402 can include an electrical module 406 for establishing a lifetime period of the temporary MAC address. In an aspect, electrical module 406 may comprise temporary MAC address lifetime managing module 210 (FIG. 2). In an additional aspect, logical grouping 402 can include an electrical module 408 for transmitting a temporary MAC address. In an aspect, electrical module 408 may comprise transmitting module 216 (FIG. 2). Furthermore, logical grouping 402 can include an electrical module 410 for determining whether the lifetime period has expired. In an aspect, electrical module 410 may comprise lifetime expiration module 214 (FIG. 2). Furthermore, logical grouping 402 can include an electrical module 412 for replacing a temporary MAC address with a newly generated temporary MAC address. In an aspect, electrical module 412 may comprise MAC address replacing module 208 and/or temporary MAC address generating module 202 (FIG. 2).

Additionally, system 400 can include a memory 414 that retains instructions for executing functions associated with the electrical modules 404, 406, 408, 410, and 412, stores data used or obtained by the electrical modules 404, 406, 408, 410, and 412, etc. While shown as being external to memory 414, it is to be understood that one or more of the electrical modules 404, 406, 408, 410, and 412 can exist within memory 414. In one example, electrical modules 404, 406, 408, 410, and 412 can comprise at least one processor, or each electrical module 404, 406, 408, 410, and 412 can be a corresponding module of at least one processor. Moreover, in an additional or alternative example, electrical modules 404, 406, 408, 410, and 412 can be a computer program product including a computer readable medium, where each electrical module 404, 406, 408, 410, and 412 can be corresponding code.

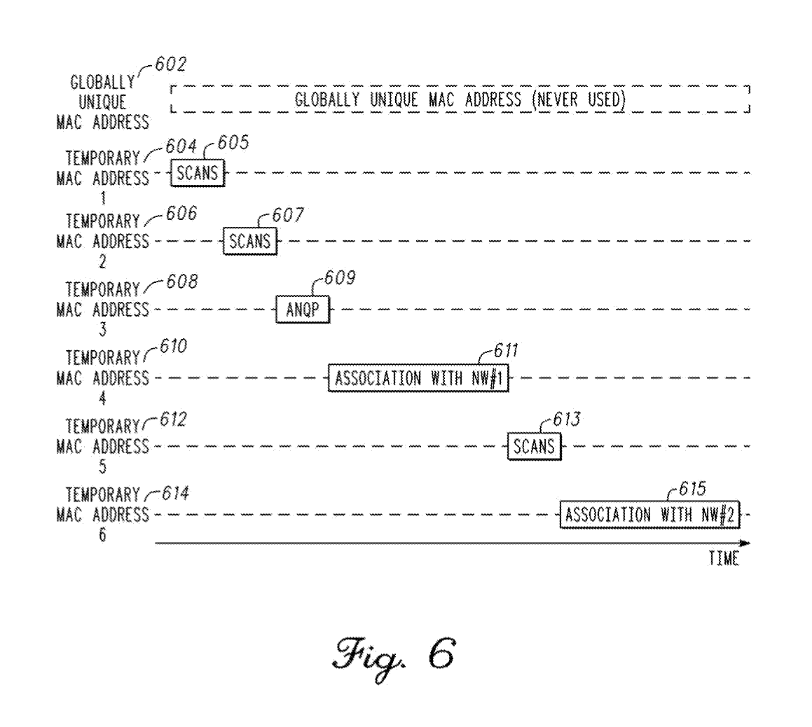

FIG. 5 is a block diagram illustrating a machine in the example form of a computer system 500, within which a set or sequence of instructions for causing the machine to perform any one of the methodologies discussed herein may be executed, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 505, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 515 (e.g., a drive unit), a signal generation device 518 (e.g., a speaker), a network interface device 520, and one or more sensors (not shown), such as a global positioning system (GPS) sensor, compass, accelerometer, or other sensor.

The storage device 515 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 505, and/or within the processor 502 during execution thereof by the computer system 500, with the main memory 504, static memory 505, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Examples, as described herein, can include, or can operate on, logic or a number of modules, modules, or mechanisms. Modules are tangible entities capable of performing specified operations and can be configured or arranged in a certain manner. In an example, circuits can be arranged (e.g., internally or with respect to external entities such as other circuits) in a specified manner as a module. In an example, the whole or part of one or more computer systems (e.g., a standalone, client or server computer system) or one or more hardware processors can be configured by firmware or software (e.g., instructions, an application portion, or an application) as a module that operates to perform specified operations. In an example, the software can reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, one instantiation of a module may not exist simultaneously with another instantiation of the same or different module. For example, where the modules comprise a general-purpose hardware processor configured using software, the general-purpose hardware processor can be configured as respective different modules at different times. Accordingly, software can configure a hardware processor, for example, to constitute a particular module at one instance of time and to constitute a different module at a different instance of time.

FIG. 6 illustrates usage of temporary MAC addresses in accordance with some embodiments. As illustrated in FIG. 6, the device MAC address 602 is not used for network operations including Access Network Query Protocol (ANQP) transmissions in which a MAC address is to be transmitted. A first temporary MAC address 604 may be used for scans 605, a second temporary MAC address 606 may be used for scans 607, a third temporary MAC address 608 may be used for ANQP transmissions 609, a fourth temporary MAC address 610 may be used for association 611 with a first network, a fifth temporary MAC address 612 may be used for scans 613, and a sixth temporary MAC address 614 may be used for association 615 with a second network. The temporary MAC addresses may be discarded between each operation for persistence of the MAC addresses.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure. The preceding description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments.

In some embodiments, a mobile station (STA) is arranged for communicating in accordance with an IEEE 802.11 technique. The STA may comprise memory to store a device MAC address and one or more processing elements. The one or more processing elements may be arranged to generate a temporary MAC address for temporary identification of the mobile station, establish a lifetime period of the temporary MAC address, and utilize the temporary MAC address during the lifetime of the temporary MAC address instead of a device MAC address for network operations, including Access Network Query Protocol (ANQP) transmissions, in which a MAC address is to be transmitted.

In some embodiments, the one or more processing elements are further arranged to refrain from transmitting or broadcasting the device MAC address for network operations, including ANQP transmissions, in which a MAC address is to be transmitted.

In some embodiments, the network operations include at least probe requests, scans, associations and ANQP transmissions and the one or more processing elements may further be arranged to discard the temporary MAC address between the network operations.

In some embodiments, the one or more processing elements may be arranged to utilize a first temporary MAC address for active scanning, and utilize a second temporary MAC address for association and authentication with an access point.

In some embodiments, the lifetime period may be selected to be one of a time period of a scan event, a time period of an association and authentication with an access point, a time period of an ANQP transmission, or a predetermined time period. In some embodiments, the predetermined time period is 10 milliseconds (ms).

In some embodiments, the one or more processing elements may further arranged to replace a prior generated temporary MAC address with a newly generated temporary MAC address when the lifetime period for the prior generated temporary MAC address has expired.

In some embodiments, the temporary MAC address comprises 48 bits, and the one or more processing elements may be arranged to generate 46 of the 48 bits of the temporary MAC address randomly. In some embodiments, the temporary MAC address comprises one of a Globally Unique Address or an Organizationally Unique Identifier. In some embodiments, the one or more processing elements are further arranged to designate the temporary MAC address as a persistent MAC address for association with an access point.

What is claimed is:

1. A mobile station (STA) comprising one or more processing elements arranged to:
generate a temporary MAC address for temporary identification of the mobile station;
establish a lifetime period of the temporary MAC address; and
utilize the temporary MAC address during the lifetime of the temporary MAC address instead of a device MAC address for network operations, including Access Network Query Protocol (ANQP) transmissions, in which a MAC address is to be transmitted.

2. The STA of claim 1 wherein the one or more processing elements are further arranged to refrain from transmitting or broadcasting the device MAC address for network operations, including ANQP transmissions, in which a MAC address is to be transmitted.

3. The STA of claim 2 wherein the network operations include at least probe requests, scans, associations and ANQP transmissions, and
wherein the one or more processing elements are further arranged to discard the temporary MAC address between the network operations.

4. The STA of claim 3 wherein the one or more processing elements are further arranged to utilize a first temporary MAC address for active scanning, and utilize a second temporary MAC address for association and authentication with an access point.

5. The STA of claim 3 wherein the lifetime period is selected to be one of a time period of a scan event, a time period of an association and authentication with an access point, a time period of an ANQP transmission, or a predetermined time period.

6. The STA of claim 5 wherein the predetermined time period is 10 milliseconds (ms).

7. The STA of claim 3 wherein the one or more processing elements are further arranged to replace a prior generated temporary MAC address with a newly generated temporary MAC address when the lifetime period for the prior generated temporary MAC address has expired.

8. The STA of claim 1 wherein the temporary MAC address comprises 48 bits, and wherein the one or more processing elements are further arranged to generate 46 of the 48 bits of the temporary MAC address randomly.

9. The STA of claim 1 wherein the temporary MAC address comprises one of a Globally Unique Address or an Organizationally Unique Identifier.

10. The mobile station of claim 1 wherein the one or more processing elements are further arranged to designate the temporary MAC address as a persistent MAC address for association with an access point.

11. A method of wireless communication at a mobile station, comprising:
generating a temporary media access control (MAC) address for temporary identification of the mobile station;
establishing a lifetime period of the temporary MAC address;
determining that the lifetime period has expired; and
replacing the temporary MAC address with a newly generated temporary MAC address upon determining that the lifetime period has expired.

12. The method of claim 11, further comprising transmitting the temporary MAC address to one or more access points.

13. The method of claim 12, wherein the newly generated temporary MAC address is transmitted for association with one of the one or more access points.

14. The method of claim 11, wherein transmitting the temporary MAC address comprises transmitting the temporary MAC address to the one or more access points via a probe request.

15. The method of claim 11, wherein the lifetime period comprises a time period of a scan event.

16. The method of claim 11, further comprising designating one of the temporary MAC address or the newly generated temporary MAC address as a persistent MAC address associated with an access point.

17. The method of claim 11 further comprising utilizing the temporary MAC address during the lifetime of the temporary MAC address instead of a device MAC address for network operations, including Access Network Query Protocol (ANQP) transmissions, in which a MAC address is to be transmitted in an unsecured manner.

18. A non-transitory computer-readable storage medium that stores instructions for execution by one or more processors to perform operations for a mobile station (STA) having a device media-access control (MAC) address, the operations cause one or more processors to:
generate a temporary MAC address for temporary identification of the mobile station;
establish a lifetime period of the temporary MAC address; and
utilize the temporary MAC address during the lifetime of the temporary MAC address instead of the device MAC address for network operations, including Access Network Query Protocol (ANQP) transmissions, in which a MAC address is to be transmitted.

19. The non-transitory computer-readable storage medium of claim 18 wherein the operations to further cause one or more processors to refrain from transmitting or broadcasting the device MAC address for network operations, including ANQP transmissions, in which a MAC address is to be transmitted.

20. The non-transitory computer-readable storage medium of claim 18 wherein the network operations include at least probe requests, scans, associations and ANQP transmissions, and
wherein the operations to further cause one or more processors to discard the temporary MAC address between the network operations.

21. A mobile station (STA) arranged for communicating in accordance with an IEEE 802.11 technique, the STA comprising:
memory to store a device media-access control (MAC) address; and
one or more processing elements arranged to:
generate a temporary MAC address for temporary identification of the mobile station;
establish a lifetime period of the temporary MAC address; and
utilize the temporary MAC address during the lifetime of the temporary MAC address instead of the device MAC address for network operations, including Access Network Query Protocol (ANQP) transmissions, in which a MAC address is to be transmitted.

22. The STA of claim 21 wherein the one or more processing elements are further arranged to refrain from transmitting or broadcasting the device MAC address for network operations, including ANQP transmissions, in which a MAC address is to be transmitted,
wherein the network operations include at least probe requests, scans, associations and ANQP transmissions, and
wherein the one or more processing elements are further arranged to discard the temporary MAC address between the network operations.
